(19) United States
(12) Patent Application Publication
(10) Pub. No.: US 2024/0427597 A1
(43) Pub. Date: Dec. 26, 2024

(54) CONDITIONAL BRANCH INSTRUCTIONS FOR AGGREGATING CONDITIONAL BRANCH OPERATIONS

(71) Applicant: TEXAS INSTRUMENTS INCORPORATED, Dallas, TX (US)

(72) Inventors: Alexander Tessarolo, Lindfield (AU); Venkatesh Natarajan, Bangalore (IN)

(21) Appl. No.: 18/604,043

(22) Filed: Mar. 13, 2024

(30) Foreign Application Priority Data
Jun. 23, 2023 (IN) 202341042581

(51) Int. Cl. G06F 9/30; G06F 9/38

(52) U.S. Cl. CPC G06F 9/30058; G06F 9/3016; G06F 9/3804

(57) ABSTRACT

Various embodiments of the present disclosure relate to the conditional execution of program code. In an example embodiment, a system including instruction fetch circuitry, decoder circuitry, and condition aggregation circuitry is provided. The instruction fetch circuitry is configured to fetch a conditional branch instruction (CBI) from memory which identifies multiple register locations and a condition aggregation operation. The condition aggregation operation is representative of an instruction which identifies multiple conditions to be checked. The instruction fetch circuitry provides the CBI to the decoder circuitry. In response, the decoder circuitry is configured to cause the condition aggregation circuitry to perform the multiple conditions checks with respect to values stored in the multiple register locations.

### CROSS-REFERENCE TO RELATED APPLICATIONS

This application is related to, and claims the benefit of priority to, India Provisional Patent Application No. 202341042581, filed on Jun. 23, 2023, and entitled “A technique for optimizing conditional branches and conditional execution based on a complex combination of multiple conditions”, which is hereby incorporated by reference in its entirety.

### TECHNICAL FIELD

This disclosure relates generally to computing hardware and software and, in particular, to conditional branch instructions.

### BACKGROUND

A conditional branch statement is representative of a type of program statement which supports the conditional execution of code. For example, a conditional branch statement in the source code of a software program may instruct the program to branch to another part of the program upon a specified condition being true.

The source code of a software program is ultimately compiled down to binary program instructions that are executed by circuitry on computing devices. In the case of a conditional branch statement, the resulting program instructions may include, for example, a compare instruction and a branch instruction, both of which are executed by corresponding circuitry on a computing device.

Multi-condition branch statements involve the evaluation of multiple conditions. In a simple example, a statement in source code may call for the evaluation of two conditions, the results of which control the order of execution of the software program. The compiled code produced from such multi-condition branch statements include a long series of compare and branch instructions that require numerous execution cycles to complete. More complicated examples of multi-condition branch statements may result in even longer chains of compare and branch instructions, and thus even more execution cycles.

Problematically, current techniques for executing conditional branch statements may be limited to checking one condition at a time. As a result, devices that implement conditional branching techniques can be expensive in execution cycles. Furthermore, when compiled down to binary program instructions, conditional branch statements increase the size of a program and thus the memory requirements of the executing device.

### SUMMARY

Disclosed herein are improvements to the compilation and execution of multi-condition branch statements. In various example embodiments, a conditional branch instruction (CBI) is introduced that directs a processing system, or components thereof, to aggregate multiple condition checks of a conditional branch statement, thereby reducing the number of execution cycles required to evaluate multiple conditions.

In one example embodiment, a system includes instruction fetch circuitry, decoder circuitry coupled to the instruction circuitry, and condition aggregation circuitry coupled to the decoder circuitry. The instruction fetch circuitry fetches a CBI from a memory. The CBI identifies multiple register locations and a condition aggregation operation. The condition aggregation operation identifies the multiple condition checks to be performed by condition aggregation circuitry. The instruction fetch circuitry provides the CBI to the decoder circuitry. In response, the decoder circuitry causes the condition aggregation circuitry to perform the multiple conditions checks with respect to values stored in the multiple register locations.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operating environment in an implementation.

FIG. 2 illustrates a conditional branch aggregation process in an implementation.

FIG. 3 illustrates an operational sequence in an implementation.

FIG. 4 illustrates an operating environment in an implementation.

FIGS. 5A, 5B, 5C, 5D, and 5E illustrate an operational scenario in an implementation.

FIG. 6 illustrates a computing system suitable for implementing the various operational environments, architectures, processes, scenarios, and sequences discussed below with respect to the other Figures.

### DETAILED DESCRIPTION

Technology is disclosed herein for the improved execution of multi-condition branch logic. Multi-condition branch logic involves the evaluation of multiple conditions, the result of which determines the execution path of a program. When executed, multi-condition branch logic causes a central processing unit (CPU) to determine if a set of conditions are true or false and output a result. Based on the resulting value, the CPU can then decide the next section of the program to branch to.

For example, multi-condition branch logic in source code may call for a program to branch to a different section of the program if one variable is less than a second variable, and if the second variable is greater than a third variable (i.e., x<y>z). If both conditions are true, the program branches to the specified section of code, else the program may continue its linear operations.

Existing techniques implement the multi-condition branch logic discussed above via a long sequence of compare and branch instructions. For example, a first compare instruction causes circuitry to compare the first and second variables (i.e., x<y), and to store a result (e.g., 1 or 0) of the first comparison in a register. A first branch instruction follows the first compare instruction, which causes circuitry to evaluate the result of the first comparison. If true, the first branch instruction causes the circuitry to branch to a section of the program which includes a second compare instruction. The second compare instruction causes the circuitry to compare the second and third variables (i.e., y>z) and store that result (e.g., 1 or 0) in a second register. The second compare instruction is followed by a second branch instruction which evaluates the result of the second comparison. If true, the second branch instruction causes the circuitry to branch to a specified section of the program in memory.

All told, the example multi-condition branch logic may utilize a minimum of two conditional checks (i.e., the first and second compare instructions) and two conditional branch operations (i.e., the first and second branch instructions). Consequently, conditional branch operations in pipelined processors can require multiple execution cycles to complete and thus can become expensive to execute. In contrast, disclosed herein is a new conditional branch instruction (CBI) that executes multi-condition branch logic within a single execution cycle.

To begin, the same multi-condition branch logic expressed in source code is compiled into two compare instructions (i.e., x<y and y>z), the results of which are stored in two registers. The comparison of those two results—rather than taking two execution cycles to complete, may be accomplished in a single execution cycle by the new CBI. In this context, a single execution cycle includes both a condition where the processing circuitry (e.g., processing circuitry 105 discussed below) is able to proceed from receipt of an instruction to a result in a single clock cycle as well as a pipelined architecture where the processing circuitry takes several clock cycles to proceed from receipt of an instruction to a result but the instruction takes up only a single slot in the pipeline. In this latter case, a first instruction may permit a second instruction to complete in the clock cycle immediately before the first instruction completes and may permit a third instruction to complete in the clock cycle immediately after the first instruction completes. Thus, in effect, the first instruction only delays the subsequent third instruction by one clock cycle.

The new CBI takes the results of the two or more compare instructions as input and evaluates their results in a single cycle in accordance with the logic expressed in the source code, whether that be AND, OR, XOR, or other such Boolean logic. Advantageously, the new CBI allows the same multi-condition branch logic to be executed in just one cycle, while the existing solutions described above require multiple cycles. While of seemingly modest benefit, such an improvement scales as the logical combinations increase.

In a brief example, source code may necessitate the evaluation of two separate AND statements, combined via an OR statement (e.g., if: a<y<b or x<y<z). Existing techniques may utilize a minimum of four execution cycles, depending upon the variable values: 1) two or more execution cycles to evaluate the first set of two conditions; and 2) two or more execution cycles to evaluate the second set of two conditions, resulting in potentially four conditional evaluation operations and four conditional branch operations (one for each of the conditions being checked). In contrast, the CBI disclosed herein takes the output of all four conditions as input and, in one execution cycle, performs a single conditional branch operation based on an evaluation of the comparison results.

In an example embodiment, a system including instruction fetch circuitry, decoder circuitry coupled to the instruction fetch circuitry, and condition aggregation circuitry coupled to the decoder circuitry is provided. The instruction fetch circuitry is configured to fetch a conditional branch instruction (CBI) from a memory and provide the CBI to the decoder circuitry. The CBI is representative of a program instruction which instructs respective circuitry to perform one or more operations. The CBI identifies multiple register locations and a condition aggregation operation.

In an implementation, the multiple register locations include four status register locations. The status register locations are representative of registers which store results of first-order condition checks. First-order condition checks represent a first set of comparison operations performed by the processing circuitry of the CPU. For example, an arithmetic logic unit may perform the first set of comparison operations and a program control unit may check the results of the arithmetic logic unit and store an indication of each result in a different status register. Output of the program control unit indicates if the comparison operations identified by the first-order condition checks were true or false.

The condition aggregation operation of the CBI is representative of a hexadecimal value that identifies multiple condition checks to be performed and a desired combination for the multiple condition checks. In an implementation the multiple condition checks of the condition aggregation operation are representative of second-order condition checks. Second-order condition checks represent a second set of comparison operations that are performed with respect to the results of the first-order condition checks. In an implementation, the second-order condition checks allow for any logical combination of the results of the first-order condition checks to be performed. In an example, the condition aggregation operation specifies whether to branch based on various combinations of the first-order condition checks by specifying a look-up table (LUT) for the combinations of first-order condition checks.

Upon receiving the CBI, the decoder circuitry causes the condition aggregation circuitry to perform the multiple condition checks with respect to the values stored in the multiple register locations. As a result, the condition aggregation circuitry outputs either a true indication, or a false indication, depending on if the results of the first-order condition checks satisfied the requirements of the second-order condition checks.

In an implementation, the condition aggregation circuitry includes LUT circuitry for performing the second-order condition checks of the condition aggregation operation. In operation, the LUT circuitry receives the CBI and in response outputs a result of the second-order condition checks. When the second-order condition checks are satisfied, the LUT circuitry outputs a true indication, else the LUT circuitry outputs a false indication. Based on the output of the LUT circuitry, the instruction fetch circuitry can determine the next instruction to execute.

Advantageously, the disclosed technology improves the efficiency of systems that utilize conditional branching techniques. Existing solutions for executing multi-condition branch logic were limited to checking one condition at a time. As such, existing solutions require numerous execution cycles to perform conditional branching operations. Instead, described herein, are systems and methods for executing multiple conditions checks within a single execution cycle thereby reducing the time and code size required for executing multi-condition branch logic.

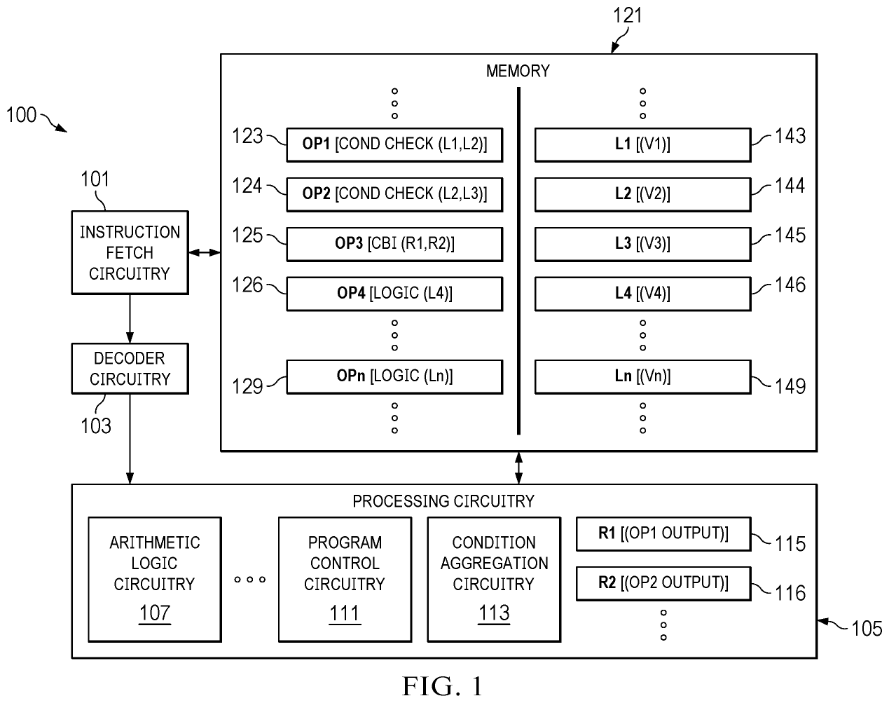

Now turning to the figures, FIG. 1 illustrates operating environment 100 in an implementation. Operating environment 100 is representative of an example operating environment configurable to execute program code, such as conditional branch instructions (CBIs). Operating environment 100 includes instruction fetch circuitry 101, decoder circuitry 103, processing circuitry 105, and memory 121. In some embodiments, the elements shown in operating environment 100 may be included inside a processing system, such as a microcontroller unit (MCU) or a central processing unit (CPU). In some embodiments, some of the elements shown in operating environment 100 may be included outside of a processing system.

Instruction fetch circuitry 101 is representative of circuitry configured to fetch instructions from a memory and provide the instructions to a decoder. For example, instruction fetch circuitry 101 may fetch instructions from memory 121 and provide the instructions to decoder circuitry 103.

Decoder circuitry 103 is representative of circuitry configured to decode instructions which were fetched from memory. For example, instruction fetch circuitry 101 may fetch an instruction from memory 121 and provide the fetched instruction to decoder circuitry 103. In response, decoder circuitry 103 decodes the fetched instruction and routes the decoded instruction to the appropriate circuitry of processing circuitry 105. In an implementation, decoded instructions identify an operation to be performed and the relevant memory locations for performing the desired operation. For example, the decoded instruction may be representative of a CBI which identifies multiple conditions to be checked and multiple register locations for performing the multiple condition checks. It should be noted that while only one decoder is illustrated in FIG. 1 (decoder circuitry 103), several decoders or decoder circuits may be included in operating environment 100. For example, each circuit of processing circuitry 105 may include separate decoder circuities.

Processing circuitry 105 is representative of one or more circuits capable of executing program instructions. Processing circuitry 105 may be coupled to instruction fetch circuitry 101, decoder circuitry 103, and memory 121. Processing circuitry 105 includes, but is not limited to, arithmetic logic circuitry 107, program control circuitry 111, condition aggregation circuitry 113, register 115, and register 116.

Arithmetic logic circuitry 107 is representative of circuitry configured to perform arithmetic operations. For example, arithmetic logic circuitry 107 may determine if a value stored in a first register location is less than, greater than, and/or equal to a value stored in a second register location. In an implementation, output of arithmetic logic circuitry 107 is stored by memory 121.

Program control circuitry 111 is representative of circuitry configured to manage the execution of program code. In various examples, program control circuitry 111 can direct instruction fetch circuitry 101 to fetch certain instructions in a specific order as other circuitries, such as arithmetic logic circuitry 107 and condition aggregation circuitry 113, execute instructions during run-time operations.

In an implementation program control circuitry 111 is further representative of circuitry configured to perform first-order condition checks. A first-order condition check is representative of an analysis performed on the results of a comparison operation. For example, arithmetic logic circuitry 107 may perform a comparison operation and program control circuitry 111 may check the output of arithmetic logic circuitry 107 to determine if the comparison operation satisfied the first-order condition check. In an implementation, program control circuitry 111 stores results of the first-order condition checks in the registers of processing circuitry 105. For example, if program control circuitry 111 determines a first-order condition is satisfied, then program control circuitry 111 may store a one in register 115 to indicate the condition was satisfied, else program control circuitry 111 may store a zero in register 115 to indicate the condition was not satisfied. Additionally, or in the alternative, the arithmetic logic circuitry 107 may determine the first-order condition and write directly to the register 115.

Condition aggregation circuitry 113 is representative of circuitry configured to execute conditional branch instructions (CBIs). More specifically, condition aggregation circuitry 113 is representative of circuitry capable of aggregating multiple conditions of a CBI. In an implementation, a decoded CBI identifies a condition aggregation operation, and multiple register locations for performing the condition aggregation operation. The condition aggregation operation may be representative of hexadecimal value which identifies multiple conditions to be checked. The multiple conditions identified by the condition aggregation operation are representative of second-order condition checks. A second-order condition check describes a secondary analysis performed with respect to the results of the first-order condition checks. In an example, the second-order condition checks determine if the results stored in the registers of processing circuitry 105 satisfy the condition aggregation operation of the CBI. If satisfied, condition aggregation circuitry 113 outputs a true indication (e.g., 1), else condition aggregation circuitry 113 outputs a false indication (e.g., 0). The output of condition aggregation circuitry 113 is used to control the execution of the program code. For example, program control circuitry 111 may evaluate the output of condition aggregation circuitry 113 to determine the next section of program code to execute. It should be noted, that while illustrated outside of program control circuitry 111, in some cases, program control circuitry includes condition aggregation circuitry 113.

Registers 115 and 116 are representative of memory locations that store data and/or instructions for use during the execution of program code. Registers 115 and 116 may be architecturally distinct and/or be portions (e.g., distinct bits) of a single larger register. In an implementation, registers 115 and 116 are representative of registers which store the results of the first-order condition checks. For example, program control circuitry 111 may output results of first-order condition checks to registers 115 and 116 and condition aggregation circuitry 113 may analyze the data stored by registers 115 and 116 to form a determination. It should be noted that while only two registers are illustrated, processing circuitry 105 may contain more than two registers.

Memory 121 is representative of one or more volatile or non-volatile computer-readable storage media including instructions, data, and the like (e.g., random access memory, flash memory). For example, memory 121 stores instructions 123,124, 125, 126 and 129, and includes memory locations 143, 144, 145, 146, and 149. The instructions of memory 121 direct the circuitries of processing circuitry 105 to perform various operations, while the memory locations of memory 121 store data.

Instruction 123 is representative of a first-order condition check which instructs arithmetic logic circuitry 107 and program control circuitry 111 to determine if the data stored in memory locations 143 and 144 satisfy the first-order condition of instruction 123. When executed, arithmetic logic circuitry 107 performs the comparison operation (e.g., greater than, less than, equal to, etc.) identified by instruction 123. Program control circuitry 111 checks the output of arithmetic logic circuitry 107 and stores an indication to whether the first-order condition was satisfied in register 115. For example, program control circuitry 111 may store a one if the condition was satisfied and store a zero if the condition was not satisfied. Additionally, or in the alternative, the arithmetic logic circuitry 107 may write directly to the register 115.

Similarly, instruction 124 is also representative of a first-order condition check which instructs arithmetic logic circuitry 107 and program control circuitry 111 to determine if the data stored in memory locations 144 and 145 satisfy the first-order condition of instruction 124. When executed, arithmetic logic circuitry 107 performs the comparison operation identified by instruction 124. Program control circuitry 111 and/or the arithmetic logic circuit 107 itself checks the output of arithmetic logic circuitry 107 and stores an indication (e.g., 1 or 0) to whether the first-order condition was satisfied in register 116.

Instruction 125 is representative of a CBI which identifies a condition aggregation operation and multiple register locations for performing the condition aggregation operation. When executed, instruction 125 causes condition aggregation circuitry 113 to determine if the results stored in registers 115 and 116 satisfy the condition aggregation operation of instruction 125. Program control circuitry 111 may evaluate the output of condition aggregation circuitry 113 to determine the next section of program code to execute. If the condition aggregation operation is satisfied, then condition aggregation circuitry 113 may output a one, else condition aggregation circuitry 113 may output a zero.

Instructions 126 and 129 are representative of program instructions that depend on the results of instruction 125. For example, if the output of condition aggregation circuitry 113 indicates the condition aggregation operation was not satisfied, then program control circuitry 111 may instruct instruction fetch circuitry 101 to fetch instruction 126 from memory 121 (to continue its linear operations). Alternatively, if the output of condition aggregation circuitry 113 indicates the condition aggregation operation was satisfied, then program control circuitry 111 may instruct instruction fetch circuitry 101 to fetch instruction 129 from memory 121.

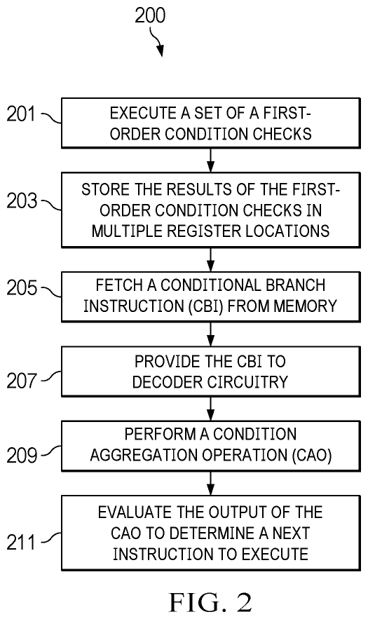

FIG. 2 illustrates conditional branch aggregation (CBA) process 200 in an implementation. CBA process 200 may be implemented in the context of program instructions that, when executed by a suitable computing system, direct the processing circuitry of the computing system to operate as follows, referring parenthetically to the steps in FIG. 2. For the purposes of explanation CBA process 200 will be explained with the elements of FIG. 1. This is not meant to limit the applications of CBA process 200, but rather to provide an example.

To begin, program control circuitry 111 executes a set of first-order condition checks (step 201). For example, program control circuitry 111 may execute instruction 123 and instruction 124. Instructions 123 and 124 are representative of instructions which direct arithmetic logic circuitry 107 and program control circuitry 111 to determine if the data stored in the identified memory locations satisfies the first-order conditions of the instructions (e.g., is a<y; is y<b; is x<y; is y<2; etc.). For example, instruction 123 directs arithmetic logic circuitry 107 and program control circuitry 111 to determine if the data stored in memory locations 143 and 144 satisfies the first-order condition of instruction 123. Similarly, instruction 124 directs arithmetic logic circuitry 107 and program control circuitry 111 to determine if the data stored in memory locations 144 and 145 satisfies the first-order condition of instruction 124.

Next, program control circuitry 111 stores the results of the first-order condition checks in multiple register locations (step 203). In an implementation, program control circuitry 111 stores the results of the first-order condition checks in the registers of processing circuitry 105. For example, program control circuitry 111 may store the results of instruction 123 in register 115 and the results of instruction 124 in register 116. If the comparison operation was satisfied, program control circuitry 111 stores a one to indicate the comparison operation was true, else program control circuitry 111 stores a zero to indicate the comparison operation was false.

Instruction fetch circuitry 101 also fetches a CBI from memory 121 (step 205). For example, instruction fetch circuitry 101 may fetch instruction 125 from memory 121. Once fetched, instruction fetch circuitry 101 provides instruction 125 to decoder circuitry 103 (step 207). In response, decoder circuitry 103 decodes instruction 125 and routes the decoded representation of instruction 125 to condition aggregation circuitry 113. The decoded representation of instruction 125 identifies a condition aggregation operation and multiple register locations for performing the condition aggregation operation.

Condition aggregation circuitry 113 receives the decoded representation of instruction 125 and in response performs the condition aggregation operation of instruction 125 (step 209). The condition aggregation operation is representative of a hexadecimal value which identifies multiple conditions to be checked. In an implementation, the hexadecimal value of the condition aggregation operation defines the desired output of the first-order condition checks. For example, the hexadecimal value may define that the output of instruction 123 should be false while the output of instruction 124 should be true. Upon determining if the results of the first-order condition checks satisfy the condition aggregation operation, condition aggregation circuitry 113 outputs a result. In an implementation, condition aggregation circuitry 113 outputs a one to indicate a true output, and outputs a zero to indicate a false output.

Finally, program control circuitry 111 evaluates the output of condition aggregation circuitry 113 to determine which instruction should be executed next (step 211). This may include fetching the next instruction from memory 121 particularly when an unpredicted branch is taken. For example, if the output of condition aggregation circuitry 113 indicates the condition aggregation operation was not satisfied, then program control circuitry 111 may direct instruction fetch circuitry 101 to fetch instruction 126 from memory 121. Alternatively, if the output of condition aggregation circuitry 113 indicates the condition aggregation operation was satisfied, then program control circuitry 111 may direct instruction fetch circuitry 101 to fetch instruction 129 from memory 121.

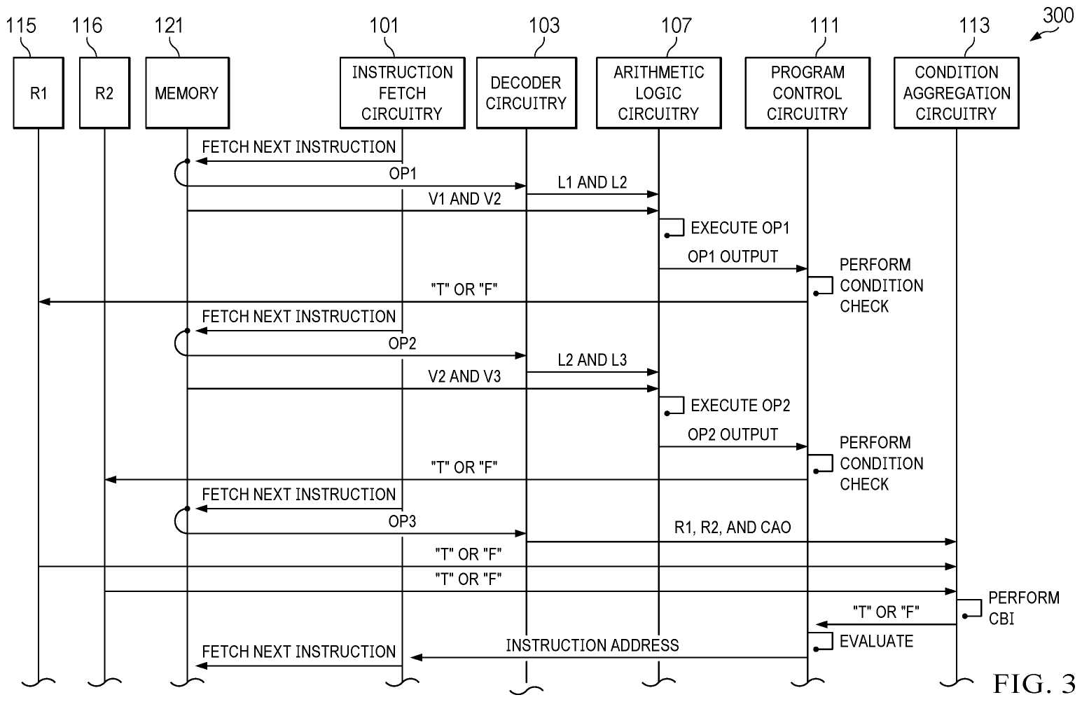

FIG. 3 illustrates operational sequence 300 in an implementation. Operational sequence 300 illustrates an application of CBA process 200 with respect to the elements of FIG. 1. As such, operational sequence 300 includes register 115, register 116, memory 121, instruction fetch circuitry 101, decoder circuitry 103, arithmetic logic circuitry 107, program control circuitry 111, and condition aggregation circuitry 113.

To begin, instruction fetch circuitry 101 fetches an instruction from memory 121. For example, instruction fetch circuitry 101 may fetch instruction 123 from memory 121. Instruction 123 is representative of a first-order condition check which identifies a first comparison operation (i.e., OP1) to be performed, and memory locations for performing the first comparison operation. Instruction fetch circuitry 101 provides instruction 123 to decoder circuitry 103. Decoder circuitry 103 decodes instruction 123 and provides the relevant memory locations (i.e., L1 and L2) for performing the first comparison operation to arithmetic logic circuitry 107.

Arithmetic logic circuitry 107 receives the relevant memory locations and in response reads the values (i.e., V1 and V2) stored by the relevant memory locations. Next, arithmetic logic circuitry 107 performs the first comparison operation. For example, arithmetic logic circuitry 107 may determine if V1 is greater than, less than, or equal to V2. Once determined, program control circuitry 111 analyzes the output of arithmetic logic circuitry 107 to determine if the result of the first comparison operation satisfied the first-order condition of instruction 123. If satisfied, program control circuitry 111 stores a true indication (e.g., 1) in register 115, else program control circuitry 111 stores a false indication (e.g., 0).

Instruction fetch circuitry 101 fetches a next instruction from memory 121. For example, instruction fetch circuitry 101 may fetch instruction 124 from memory 121. Instruction 124 is representative of another first-order condition check which identifies a second comparison operation (i.e., OP2) to be performed, and memory locations for performing the second comparison operation. Instruction fetch circuitry 101 provides instruction 124 to decoder circuitry 103. Decoder circuitry 103 decodes instruction 124 and provides the relevant memory locations (i.e., L2 and L3) for performing the second comparison operation to arithmetic logic circuitry 107.

Arithmetic logic circuitry 107 receives the relevant memory locations and in response reads the values (i.e., V2 and V3) stored by the relevant memory locations. Next, arithmetic logic circuitry 107 performs the second comparison operation and outputs a result of the second comparison operation to program control circuitry 111. Program control circuitry 111 analyzes the output of arithmetic logic circuitry 107 and determines if the result of the second comparison operation satisfied the first-order condition of instruction 124. If satisfied, program control circuitry 111 stores a true indication (e.g., 1) in register 116, else program control circuitry 111 stores a false indication (e.g., 0).

Instruction fetch circuitry 101 fetches a next instruction from memory 121. For example, instruction fetch circuitry 101 may fetch instruction 125 from memory 121. Instruction 125 is representative of a conditional branch instruction (CBI) that identifies a condition aggregation operation (CAO) and multiple register locations for performing the CAO. In an implementation, the CAO is representative of a hexadecimal value that defines the desired output for the first-order condition checks. For example, the CAO may define that for the CBI to be true, the first comparison operation must be false, and the second comparison operation must be true. Instruction fetch circuitry 101 provides instruction 125 to decoder circuitry 103. In response, decoder circuitry 103 decodes instruction 125 and provides the CAO and the relevant register locations for performing the CAO to condition aggregation circuitry 113.

Condition aggregation circuitry 113 receives the CAO and the relevant register location and in response reads the values (i.e., OP1 output and OP2 output) stored by the relevant registers. Next, condition aggregation circuitry 113 determines if the results of the first-order condition checks satisfy the CAO of instruction 125. If the results of the first-order condition checks satisfy the CAO, then condition aggregation circuitry 113 outputs a true indication, else condition aggregation circuitry 113 outputs a false indication. In an implementation, condition aggregation circuitry 113 outputs a one to indicate a true output, and a zero to indicate false output.

Finally, program control circuitry 111 evaluates the output of condition aggregation circuitry 113 and determines the next instruction that should be executed. This may include fetching the next instruction from memory 121. For example, if the output of condition aggregation circuitry 113 indicates a false output, then program control circuitry 111 may cause instruction 126 to be executed. Alternatively, if the output of condition aggregation circuitry 113 indicates a true output, then program control circuitry 111 may cause instruction 129 to be executed. In an implementation, instruction fetch circuitry 101 receives the address of the next instruction to be executed from program control circuitry 111 and in response, determines whether to fetch the instruction from memory 121. It should be noted that instruction fetch circuitry 101 may fetch more than one instruction at a time from memory 121. For example, instruction fetch circuitry 101 may fetch one or more instruction packets from memory 121.

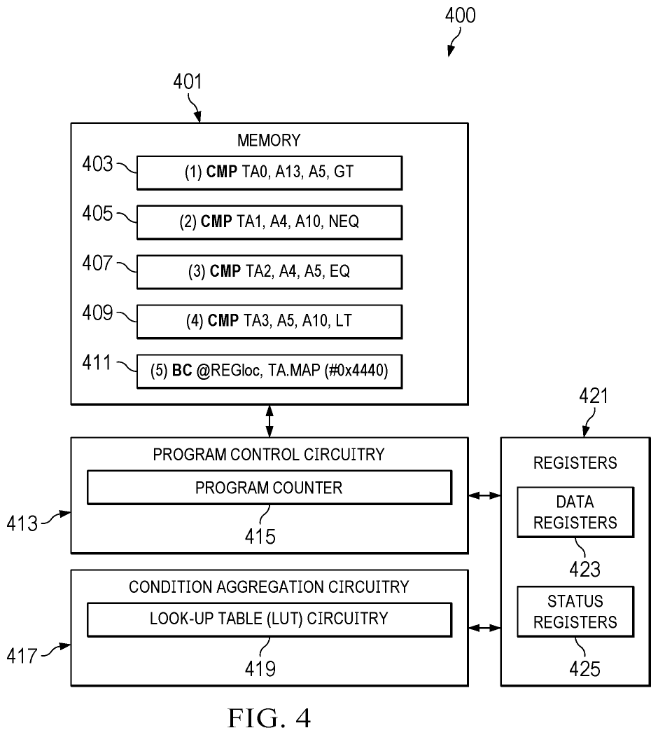

Now turning to the next figure, FIG. 4 illustrates operating environment 400 in an implementation. Operating environment 400 is representative of another example operating environment configurable to execute program code such as conditional branch instructions. Operating environment 400 includes, but is not limited to, memory 401, program control circuitry 413, condition aggregation circuitry 417, and registers 421. In some embodiments, the elements shown in operating environment 400 may be included inside a processing system, such as a microcontroller unit (MCU) or a central processing unit (CPU). In some embodiments, some of the elements shown in operating environment 400 may be included outside of a processing system.

Memory 401 is representative of one or more volatile or non-volatile computer-readable storage media including instructions, data, and the like thereon (e.g., random access memory, flash memory). For example, memory 401 includes instructions 403, 405, 407, 409 and 411. Memory 401 may be coupled to circuitry (e.g., instruction fetch circuitry 101) configured to fetch instructions from memory 401 and provide the instructions to the appropriate circuitry. In an implementation memory 401 is representative of memory 121 of FIG. 1.

Instructions 403, 405, 407, and 409 are representative of first-order condition checks which instruct program control circuitry 413 to determine if first set of comparison operations are true or false. In an implementation, instructions 403, 405, 407, 409 can all be issued in parallel in a single instruction packet and executed in a single execution cycle. When executed, instructions 403, 405, 407, and 409 direct program control circuitry 413 to determine how data stored in a first memory location compares to data stored in a second memory location. Instructions 403, 405, 407, and 409 further direct program control circuitry 413 to output a result of each comparison operation to a specified destination register. For example, instruction 403 directs program control circuitry 413 to determine if the data stored by register A13 is greater than the data stored by register A5 and to output a result of the comparison to register TA0.

Instruction 411 is representative of a second-order condition check which instructs condition aggregation circuitry 417 to perform a second set of comparison operations. More specifically, instruction 411 is representative of a CBI which identifies a condition aggregation operation and multiple register locations for performing the condition aggregation operation. The multiple register locations of instruction 411 include the registers which store results of the first-order condition checks. The condition aggregation operation is a hexadecimal value (i.e., “0x4440”) which defines the desired outputs for the first-order condition checks. In an example, each bit position in the hexadecimal value represents a combination of first-order condition checks similar to a LUT and the bit value indicates the output for the respective combination of first-order condition checks. When executed, instruction 411 directs condition aggregation circuitry 417 to determine how the results of the first-order condition checks compare to the condition aggregation operation. If the results of the first-order condition checks satisfy the condition aggregation operation, then condition aggregation circuitry 417 outputs a true indication (e.g., 1), else condition aggregation circuitry 417 outputs a false indication (e.g., 0).

Program control circuitry 413 is representative of one or more circuits configured to manage the execution of program code (e.g., program control circuitry 111). Program control circuitry 413 is further representative of circuitry configured to execute first-order condition checks. For example, program control circuitry 413 may execute instructions 403, 405, 407, and 409. In an implementation, program control circuitry is coupled to an arithmetic logic unit (e.g., arithmetic logic circuitry 107) configured to perform arithmetic operations. For example, the arithmetic logic unit may perform the comparison operations, and program control circuitry 413 may analyze the outputs of the arithmetic logic unit to determine if the first-order conditions were satisfied. Program control circuitry 413 includes program counter 415.

Program counter 415 is representative of a register which stores the memory location for the instruction which is currently being executed. For example, if program control circuitry 413 is currently executing instruction 407, then program counter 415 stores the address that corresponds to the location in memory 401 which stores instruction 407.

Condition aggregation circuitry 417 is representative of one or more circuits configured to execute conditional branch instructions. For example, condition aggregation circuitry 417 may execute instruction 411 of memory 401. Condition aggregation circuitry 417 may further be representative of circuitry configured to perform conditional execution of a designated set of instruction packets. In an implementation condition aggregation circuitry 417 is representative of condition aggregation circuitry 113 of FIG. 1. Condition aggregation circuitry 417 includes, but is not limited to, look-up table (LUT) circuitry 419.

LUT circuitry 419 is representative of circuitry configured to determine if the results of the first-order condition checks satisfy the condition aggregation operation of a conditional branch instruction. For example, LUT circuitry 419 may determine if the results of instructions 403, 405, 407, and 409 satisfy the condition aggregation operation of instruction 411. In an implementation, LUT circuitry 419 outputs a result of its determination to program control circuitry 413. Program control circuitry 413 evaluates the output of LUT circuitry 419 to determine the next instruction(s) to be executed.

Registers 421 represent memory locations that store data and/or instruction for use during the execution of program code. In an implementation, registers 421 are representative of registers 115 and 116 of FIG. 1. Registers 421 include, but are not limited to, data registers 423 and status register 425.

Data registers 423 may be representative of addressing registers, fixed-point registers, floating-point registers, or a combination thereof. As such, data registers 423 may store addressing data, fixed-point data, floating-point data, or a combination of data types. In an implementation, program control circuitry 413 performs first-order condition checks with respect to the data stored by data registers 423.

Status registers 425 may be representative of interrupt status registers, decode phase status registers, execute phase status registers, or a combination thereof. In an implementation, status registers 425 are representative of the registers which store the results of the first-order condition checks. For example, program control circuitry 413 may output results of the first-order condition checks to status registers 425 and LUT circuitry 419 may analyze the data of status registers 425 to form a determination. In an implementation, status registers 425 include four separate registers for storing the results of the first-order condition checks.

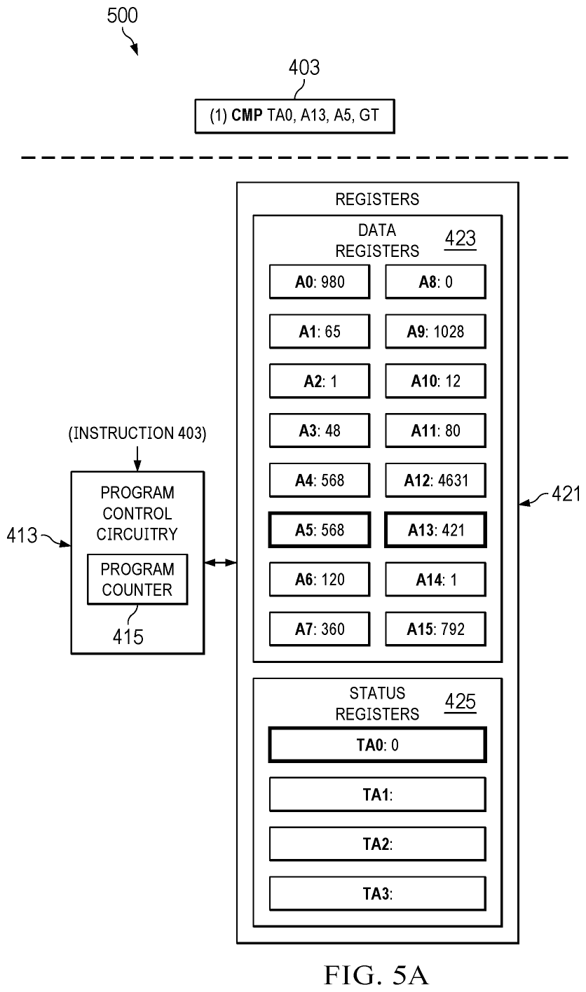

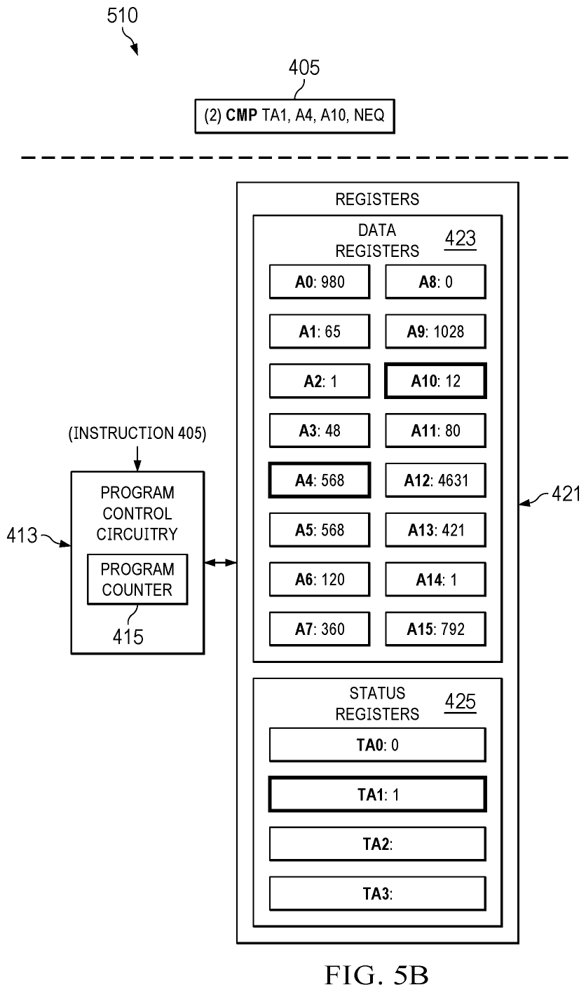

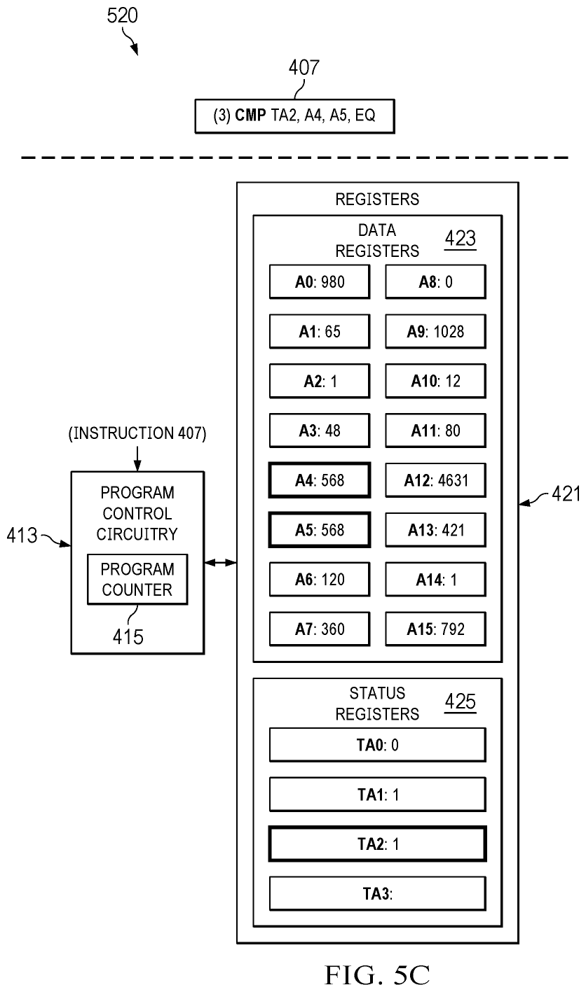

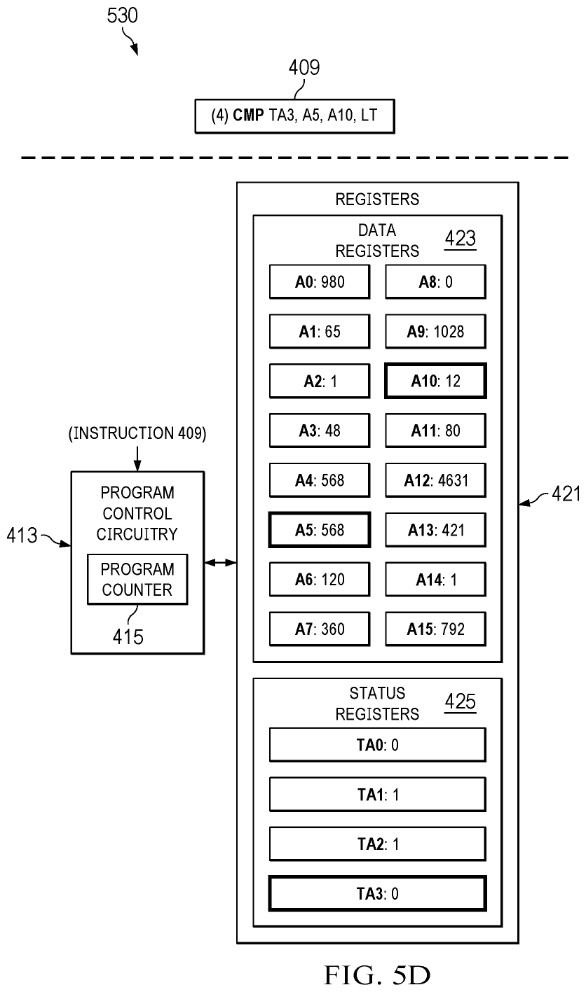

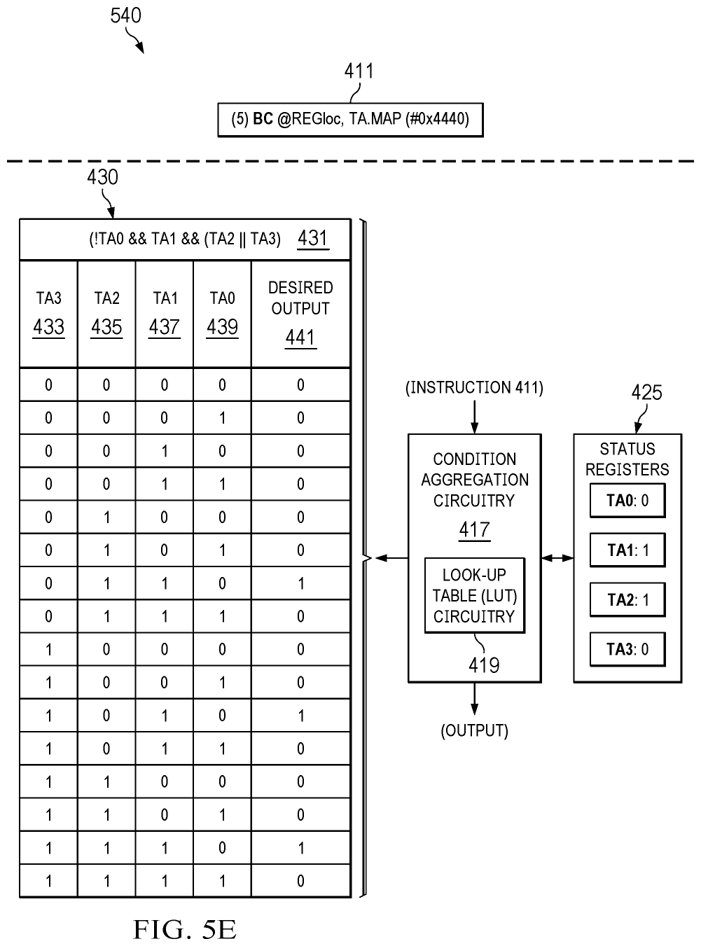

FIGS. 5A, 5B, 5C, 5D, and 5E illustrate an operational scenario for executing program code in an implementation. More specifically, FIGS. 5A-5E illustrate a sequence of stages for executing conditional branch instructions with respect to the elements of FIG. 4. In an implementation, FIG. 5A depicts a first stage of operation, FIG. 5B depicts a second stage of operation, FIG. 5C depicts a third stage of operation, FIG. 5D depicts a fourth stage of operation, and FIG. 5E depicts a fifth stage of operation.

Now turning to FIG. 5A, stage 500 is representative of the first stage of operation. Stage 500 includes instruction 403, program control circuitry 413, and registers 421. To begin, program control circuitry 413 receives instruction 403. In response, program control circuitry 413 identifies the relevant locations within data registers 423 for performing instruction 403. Once identified, program control circuitry 413 determines if the data stored by register A13 is greater than the data stored by register A5. In an implementation, an arithmetic logic unit (not shown) determines if the data stored by register A13 is greater than the data stored by register A5 and outputs a result to program control circuitry 413. Since the data of register A13 is less than the data of register A5 (i.e., 421<568), program control circuitry 413 determines the first comparison operation is false. As such, program control circuitry 413 outputs a zero to the status register which corresponds with instruction 403 (i.e., register TA0).

FIG. 5B illustrates stage 510 which is representative of the second stage of operation. Stage 510 includes instruction 405, program control circuitry 413, and registers 421. To begin, program control circuitry 413 receives instruction 405 and identifies the relevant locations within data registers 423 for performing instruction 405. Once identified, program control circuitry 413 determines if the data stored by register A4 is not equal to the data stored by register A10. Since the data of register A4 is not equal to the data of register A10 (i.e., 568≠12), program control circuitry 413 determines the second comparison operation is true. As such, program control circuitry 413 outputs a one to register TA1.

FIG. 5C illustrates stage 520 which is representative of the third stage of operation. Stage 520 includes instruction 407, program control circuitry 413, and registers 421. To begin, program control circuitry 413 receives instruction 407 and identifies the relevant locations within data registers 423 for performing instruction 407. Once identified, program control circuitry 413 determines if the data stored by register A4 is equal to the data stored by register A5. Since the data of register A4 is equal to the data of register A5 (i.e., 568=568), program control circuitry 413 determines the third comparison operation is true and outputs a one to register TA2.

FIG. 5D illustrates stage 530 which is representative of the fourth stage of operation. Stage 530 includes instruction 409, program control circuitry 413, and registers 421. To begin, program control circuitry 413 receives instruction 409 and in response, identifies the relevant locations within data registers 423 for performing instruction 409. Once identified, program control circuitry 413 determines if the data stored by register A5 is less than the data stored by register A10. Since the data of register A5 is greater than the data of register A10 (i.e., 568>12), program control circuitry 413 determines the fourth comparison operation is false and outputs a zero to register TA3. It should be noted that, stages 500, 510, 520, and 530 may be executed in parallel, but for the purposes of explanation, the stages have been illustrated separately.

FIG. 5E illustrates stage 540 which is representative of the fifth stage of operation. Stage 540 includes instruction 411, condition aggregation circuitry 417, status registers 425, and look-up table (LUT) 430. LUT 430 is representative of a table specified by the condition aggregation operation of the instruction 411, utilized by LUT circuitry 419, to determine if the results of instructions 403, 405, 407, and 409, satisfy the condition aggregation operation. LUT 430 includes operation definition 431, register TA3 column 433, register TA2 column 435, register TA1 column 437, register TA0 column 439, and desired output column 441.

Operation definition 431 is representative of an alternate representation for the condition aggregation operation of a CBI. As such, operation definition 431 defines the desired output for the first-order condition checks. In the context of FIG. 5E, operation definition 431 defines that register TA0 should store a zero, register TA1 should store a one, and either one or both of registers TA2 and TA3 should store a one. In other words, operation definition 431 defines that the first comparison operation should be false, the second comparison operation should be true, and at least one of the third and fourth comparison operations should be true.

Register TA3 column 433, register TA2 column 435, register TA1 column 437, and register TA0 column 439 are representative of columns which represent every possible combination of inputs for the data stored by status registers 425. As such, the rows of each register column are representative of binary values which sequentially count from zero to fifteen. For example, the first row of the register columns corresponds to “0000” while the last row corresponds to “1111”.

Desired output column 441 is representative of column that indicates the result should the registers store the respective values of the row as defined by the condition aggregation operation of instruction 411. For example, the seventh, eleventh, and fifteenth rows of LUT 430 represent the rows which correspond to the first-order conditions “0110”, “1010”, and “1110”, and in the example, these combinations are to produce a result of “1.” In an implementation, the data of the desired output column 441 is generated based on the condition aggregation operation of instruction 411. For example, the condition aggregation operation of instruction 411 can be represented with the following hexadecimal value:
0x4440

Such that, the binary representation of the condition aggregation operation is:
0100-0100-0100-0000

Which is also representative of the data of the desired output column 441 when written from most to least significant bit.

In operation, condition aggregation circuitry 417 receives instruction 411 and routes instruction 411 to LUT circuitry 419. In response, LUT circuitry 419 determines if the values stored by status registers 425 correspond with one of the allowable combinations identified by desired output column 441. Upon determining that the values of status registers 425 correspond with the seventh row of LUT 430, LUT circuitry 419 outputs a true indication (e.g., 1). Program control circuitry 413 evaluates the output of LUT circuitry 419 and determines the next instruction(s) to be executed.

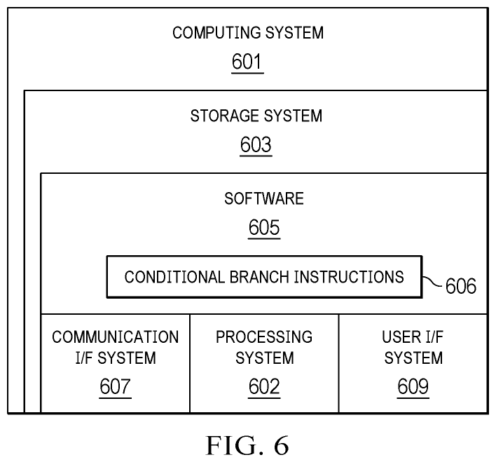

FIG. 6 illustrates an example computer system that may be used in various implementations. For example, computing system 601 is representative of a computing device capable of executing software comprised of program instructions having conditional branch instructions as described herein. Computing system 601 is representative of any system or collection of systems with which the various operational architectures, processes, scenarios, and sequences disclosed herein for conditional branching may be employed. Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609 (optional). Processing system 602 is operatively coupled with storage system 603, communication interface system 607, and user interface system 609. Computing system 601 may be representative of a cloud computing device, distributed computing device, or the like.

Processing system 602 loads and executes software 605 from storage system 603, or alternatively, runs software 605 directly from storage system 603. Software 605 includes and implements conditional branch instructions (CBIs) 606, which are representative of any of the conditional branching instructions discussed with respect to the preceding Figures (e.g., instruction 125 and instruction 411). When executed by processing system 602, software 605 (including instruction 125 and instruction 411) directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units, graphical processing units, digital signal processing units, data processing units, application specific processors, and logic devices, as well as any other type of processing device, combinations, or variations thereof. Processing system 602 includes special purpose circuitry capable of executing CBIs, examples of which include condition aggregation circuitry 113, condition aggregation circuitry 417, and LUT circuitry 419.

Storage system 603 may comprise any computer readable storage media readable and writeable by processing system 602 and capable of storing software 605. Storage system 603 may include volatile and nonvolatile, removable and non-removable, mutable and non-mutable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including CBIs 606) may be implemented in program instructions and among other functions may, when executed by processing system 602, direct processing system 602 to operate as described with respect to the various operational scenarios, sequences, and processes illustrated herein. For example, software 605 includes CBIs for implementing conditional branch operations as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded environment, in a single processor or multi-processor environment, in a single host or multi-host environment, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to provide memory access as described herein. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A system, comprising:
instruction fetch circuitry;
decoder circuitry coupled to the instruction fetch circuitry; and
condition aggregation circuitry coupled to the decoder circuitry;
wherein the instruction fetch circuitry is configured to:
fetch a conditional branch instruction from a memory, wherein the conditional branch instruction identifies multiple register locations and a condition aggregation operation, wherein the condition aggregation operation comprises multiple condition checks; and
provide the conditional branch instruction to the decoder circuitry;
wherein the decoder circuitry is configured to cause the condition aggregation circuitry to perform the multiple condition checks with respect to values stored in the multiple register locations.

2. The system of claim 1 wherein the condition aggregation circuitry is configured to perform the multiple condition checks with respect to the values stored in the multiple register locations, and wherein the conditional branch instruction comprises an identifier for the condition aggregation operation that defines the multiple condition checks.

3. The system of claim 2 wherein the condition aggregation circuitry comprises look-up table (LUT) circuitry for performing the multiple condition checks, wherein input to the LUT circuitry comprises the identifier for the condition aggregation operation and the values from the multiple register locations, and wherein an output from the LUT circuitry comprises a result of the multiple condition checks.

4. The system of claim 3 wherein the values stored in the multiple register locations comprise results of first-order condition checks, and wherein the multiple condition checks performed by the LUT circuitry comprise second-order condition checks based on the results of the first-order condition checks.

5. The system of claim 4 further comprising program control circuitry configured to:
perform the first-order condition checks; and
store each one of the results of the first-order condition checks in a different one of the multiple register locations.

6. The system of claim 4 wherein the second-order condition checks comprise a first condition check and a second condition check, and wherein the multiple register locations include a first register location and a second register location.

7. The system of claim 6 wherein the LUT circuitry is configured to:
determine if a first result stored in the first register location satisfies the first condition check and a second result stored in the second register location satisfies the second condition check;
output a false indication when the first result does not satisfy the first condition check;
output a false indication when the second result does not satisfy the second condition check; and
output a true indication when the first result satisfies the first condition check, and the second result satisfies the second condition check.

8. The system of claim 2 wherein the identifier for the condition aggregation operation comprises a hexadecimal value.

9. A computing apparatus comprising:
a memory device; and
one or more processors operatively coupled with the memory device;
wherein the one or more processors are configured to at least:
fetch a conditional branch instruction from the memory device, wherein the conditional branch instruction identifies multiple register locations and a condition aggregation operation, wherein the condition aggregation operation comprises multiple condition checks; and
perform the multiple condition checks with respect to values stored in the multiple register locations.

10. The computing apparatus of claim 9 wherein the conditional branch instruction comprises an identifier for the condition aggregation operation that defines the multiple condition checks and wherein the identifier for the condition aggregation operation comprises a hexadecimal value.

11. The computing apparatus of claim 10 wherein to perform the multiple condition checks, the one or more processors are further configured to:
receive inputs wherein the inputs comprise the identifier for the condition aggregation operation and the values from the multiple register locations; and
generate an output wherein the output comprises a result of the multiple condition checks.

12. The computing apparatus of claim 11 wherein the values stored in the multiple register locations comprise results of first-order condition checks, and wherein the multiple condition checks performed by the one or more processors comprise second-order condition checks based on the results of the first-order condition checks.

13. The computing apparatus of claim 12 wherein the one or more processors are further configured to:
perform the first-order condition checks; and
store each one of the results of the first-order condition checks in a different one of the multiple register locations.

14. The computing apparatus of claim 12 wherein the second-order condition checks comprise a first condition check and a second condition check, and wherein the multiple register locations include a first register location and a second register location.

15. The computing apparatus of claim 14 wherein the one or more processors are further configured to:
determine if a first result stored in the first register location satisfies the first condition check and a second result stored in the second register location satisfies the second condition check;
output a false indication when the first result does not satisfy the first condition check;
output a false indication when the second result does not satisfy the second condition check; and
output a true indication when the first result satisfies the first condition check, and the second result satisfies the second condition check.

16. One or more computer-readable storage media, comprising:
program instructions stored thereon comprising a conditional branch instruction that identifies multiple register locations and a condition aggregation operation, wherein the condition aggregation operation comprises multiple condition checks, and wherein the conditional branch instruction, when read and executed by processing circuitry, direct the processing circuitry to:
perform the multiple condition checks with respect to values stored in the multiple register locations.

17. The one or more computer-readable storage media of claim 16 wherein the conditional branch instruction comprises an identifier for the condition aggregation operation that defines the multiple condition checks and wherein the identifier for the condition aggregation operation comprises a hexadecimal value.

18. The one or more computer-readable storage media of claim 16 wherein the values stored in the multiple register locations comprise results of first-order condition checks, and wherein the multiple condition checks performed by the processing circuitry comprise second-order condition checks based on the results of the first-order condition checks.

19. The one or more computer-readable storage media of claim 18 wherein the program instructions further direct the processing circuitry to:
perform the first-order condition checks; and
store each one of the results of the first-order condition checks in a different one of the multiple register locations.

20. The one or more computer-readable storage media of claim 18 wherein the second-order condition checks comprise a first condition check and a second condition check, and wherein the multiple register locations include a first register location and a second register location and wherein the program instructions further direct the processing circuitry to:
determine if a first result stored in the first register location satisfies the first condition check and a second result stored in the second register location satisfies the second condition check;
output a false indication when the first result does not satisfy the first condition check;
output a false indication when the second result does not satisfy the second condition check; and
output a true indication when the first result satisfies the first condition check, and the second result satisfies the second condition check.
